(19) United States
(12) Patent Application Publication
(10) Pub. No.: US 2017/0001299 A1
(43) Pub. Date: Jan. 5, 2017

(54) TOOL BOX HAVING PIVOTAL SUPPORT

(71) Applicant: Te Chen CHU, Taichung (TW)

(72) Inventor: Te Chen CHU, Taichung (TW)

(21) Appl. No.: 14/723,545

(22) Filed: May 28, 2015

(51) Int. Cl. B25H 3/02; B25H 3/04

(52) U.S. Cl. CPC B25H 3/02; B25H 3/04

(57) ABSTRACT

A tool box includes a housing having a chamber formed by two side walls, a bracing member having two arms each pivotally engaged with the side wall, a tool supporting member having a pivot axle engaged with the side walls for mounting the tool supporting member to the housing, and two followers attached to the arms and each having an eccentric member coupled to the tool supporting member for pivoting the tool supporting member relative to the housing with the bracing member when the bracing member is pivoted relative to the housing and for suitably supporting the tool member on the tool supporting member when the housing is tilted relative to the supporting ground or table.

### BACKGROUND OF THE INVENTION

1. Field of the Invention

The present invention relates to a tool organizing device or tool box, and more particularly to a tool organizing device or tool box including a pivotal or rotatable supporting mechanism for pivotally or rotatably and solidly and stably supporting the tool members or elements in the tool box and for preventing the tool members or elements from being disengaged or separated from the tool box inadvertently.

2. Description of the Prior Art

Typical tool organizing devices or tool boxes comprise a conventional tool housing having an upper casing or cover and a lower base casing, each casing has a number of shaped grooves or cavities or socket openings for receiving tools of different shapes and sizes, each casing further has a handle for easy carriage, the upper casing includes an engaging member, and the lower casing has an engaging groove for releasably engaging with the engaging member of the upper casing, thereby preventing falling of the tools out of the toolbox.

For example, U.S. Pat. No. 4,064,992 to Ralston et al., U.S. Pat. No. 4,660,719 to Peterson et al., U.S. Pat. No. 4,972,943 to Fludd, U.S. Pat. No. 5,378,005 to Norton, and U.S. Pat. No. 6,131,740 to Huang disclose several of the typical tool organizing devices or tool boxes each comprising an upper casing or cover and a lower base casing including a number of shaped grooves or cavities for receiving tools of different shapes and sizes, and including an engaging member for releasably engaging with and coupling the casing together, and for preventing the tool members or elements from being disengaged or separated from or from falling out of the toolbox.

However, the tool members or elements may not be tilted or inclined relative to the supporting housing and may have a good chance to be disengaged or separated from or fall out of the supporting housing when the supporting housing is tilted or inclined relative to the supporting ground or surface or table and when the supporting housing is opened.

The present invention has arisen to mitigate and/or obviate the afore-described disadvantages of the conventional tool organizing devices or tool boxes.

### SUMMARY OF THE INVENTION

The primary objective of the present invention is to provide a tool box including a pivotal or rotatable supporting mechanism for pivotally or rotatably and solidly and stably supporting the tool members or elements in the tool box and for preventing the tool members or elements from being disengaged or separated from the tool box inadvertently.

In accordance with one aspect of the invention, there is provided a tool box comprising a housing including a chamber formed therein and defined by two side walls, a bracing member including two arms each having a pivot shaft engaged with the side wall of the housing for pivotally attaching the bracing member to the housing and for allowing the bracing member to be pivoted toward and away from the housing, a tool supporting member disposed in the chamber of the housing, and including a pivot axle engaged with the side walls for pivotally mounting the tool supporting member to the housing and for allowing the tool supporting member to be pivoted relative to the housing, and two followers attached to the arms respectively, and each of the followers including an eccentric member extended therefrom and coupled to the tool supporting member for pivoting or rotating the tool supporting member relative to the housing with the bracing member when the bracing member is pivoted or rotated relative to the housing.

The eccentric member of the follower is preferably pivotally coupled to the tool supporting member with a link for pivoting or rotating the tool supporting member relative to the housing. The pivot axle of the tool supporting member is preferably located a front portion of the tool supporting member, and the eccentric member of the follower is preferably pivotally coupled to a rear portion of the tool supporting member directly, or indirectly with the link.

The followers are attached or mounted to the pivot shafts of the arms respectively. The followers each include a lock or latch member engaged with the pivot shafts of the arms for solidly securing the followers to the pivot shafts of the arms respectively and for allowing the followers to be pivoted or rotated or moved in concert with the pivot shafts of the arms respectively relative to the housing.

The housing includes a recess or space formed in each of the side walls for receiving and engaging with the arms of the bracing member respectively and for storing the arms of the bracing member respectively when the arms of the bracing member are folded and moved toward the housing and engaged into the spaces of the side walls of the housing.

The tool supporting member includes at least one socket opening formed therein for supporting and engaging with a tool member. The tool supporting member includes a base panel for defining the at least one socket opening of the tool supporting member, and the base panel includes an engaging slot formed therein for receiving and engaging with and for supporting the tool member.

The housing further includes a tool supporting element disposed in the chamber of the housing and having a pivot axle or spindle engaged with the side walls of the housing for pivotally mounting the tool supporting element to the housing and thus for allowing the tool supporting element to be pivoted or rotated relative to the housing.

One of the followers include an eccentric element extended therefrom and coupled to the tool supporting element for pivoting or rotating the tool supporting element relative to the housing with the bracing member when the bracing member is pivoted or rotated relative to the housing. The eccentric element of the follower is preferably pivotally coupled to the tool supporting element with a lever.

The pivot spindle of the tool supporting element is preferably located a front portion of the tool supporting element, and the eccentric element of the follower is preferably pivotally coupled to a rear portion of the tool supporting element directly, or indirectly with the lever.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a tool box in accordance with the present invention;

FIG. 2 is another partial exploded view of the tool box;

FIG. 3 is a perspective view of the tool box;

FIG. 4 is a front plan schematic view of the tool box;

FIG. 5 is a cross sectional view of the tool box, taken along lines 5-5 of FIG. 4; and

FIG. 6 is another cross sectional view similar to FIG. 5; illustrating the operation of the tool box.

### DETAILED DESCRIPTION OF THE PREFERRED EMBODIMENT

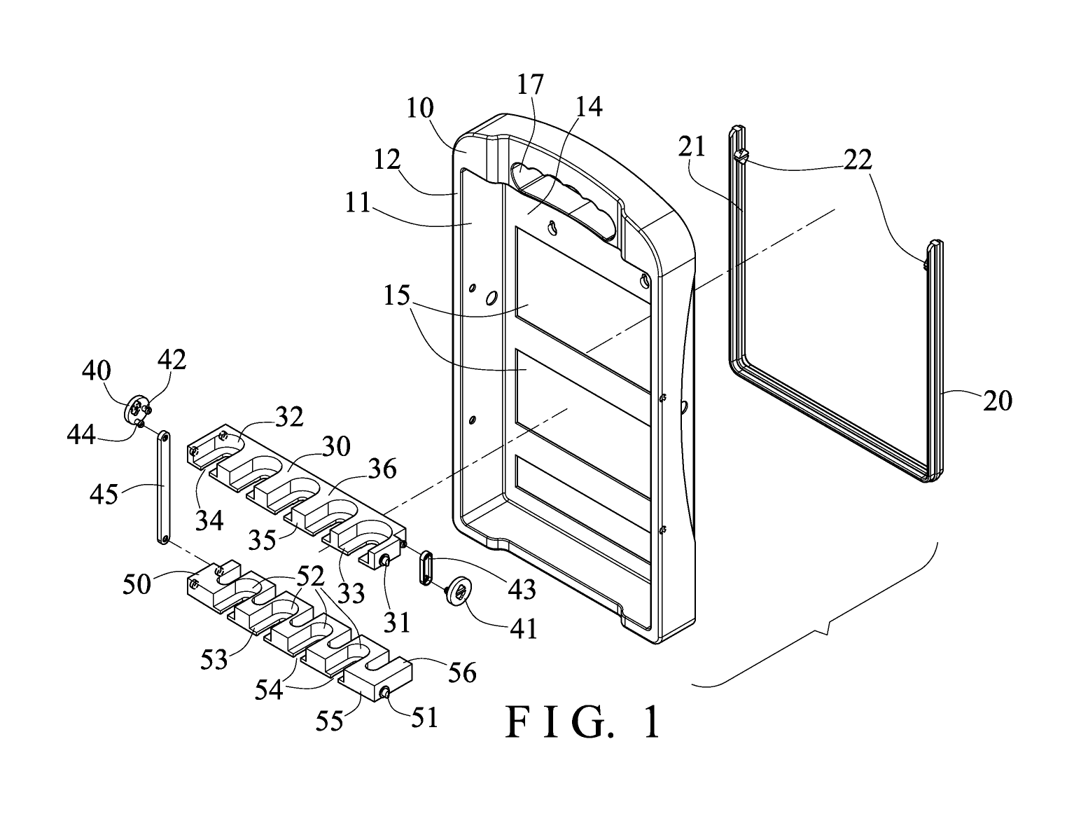

Referring to the drawings, and initially to FIGS. 1-5, a tool box in accordance with the present invention comprises an outer receptacle or housing 10 including a compartment or chamber 11 formed therein and formed or defined by two side panels or walls 12, 13, and a bottom panel or wall 14, and including one or more windows or orifices 15 formed in the bottom wall 14 and communicating with the chamber 11 of the housing 10, and including a relatively smaller chamber or compartment or space 16 formed therein, such as formed in the rear or lower portion of each of the side walls 12, 13, and including another opening or handle 17 formed or provided on the upper portion or on one or first end portion thereof for carrying purposes.

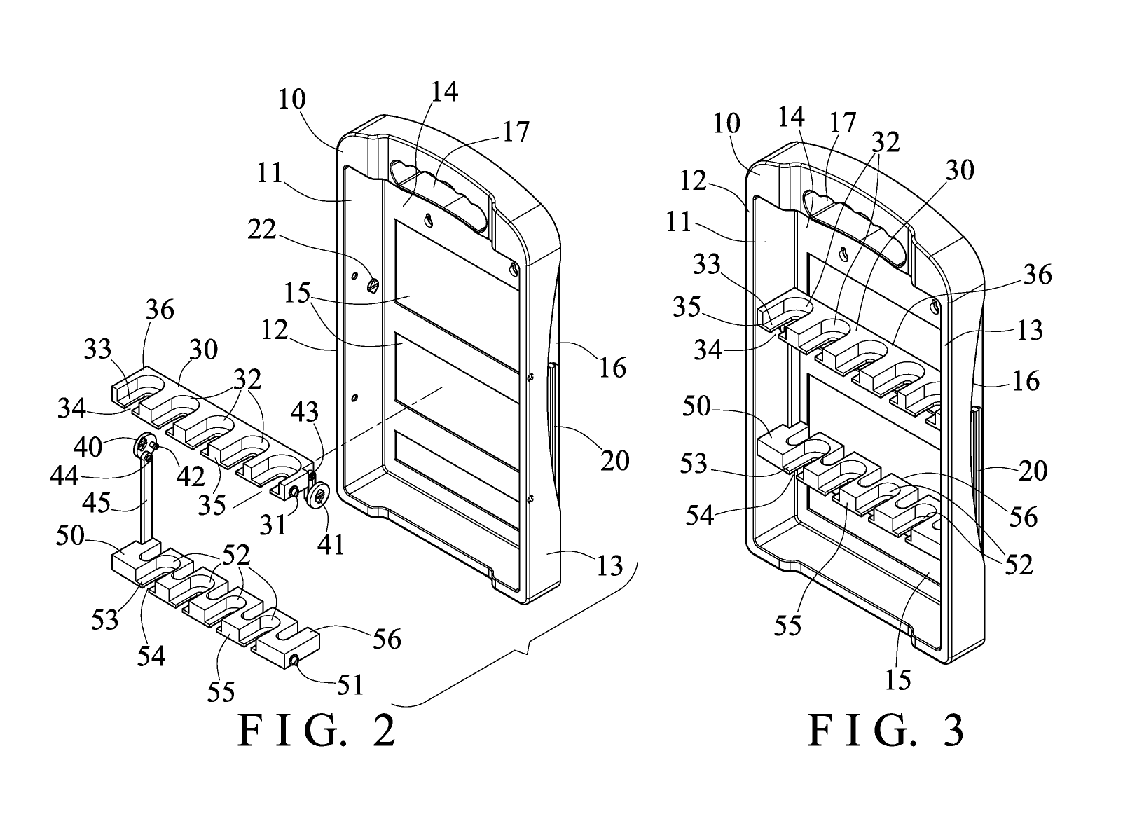

A U-shaped stay or bracing member 20 includes two legs or arms 21 received or engageable in the spaces 16 of the side walls 12, 13 (FIGS. 2, 3) and pivotal or movable out of the spaces 16 of the side walls 12, 13 (FIG. 6), and the arms 21 each include a pivot axle or shaft 22 provided thereon or extended therefrom and engaged through the respective side walls 12, 13, and extended or engaged into the chamber 11 of the housing 10 (FIG. 2) for pivotally or rotatably attaching or mounting or securing or coupling the bracing member 20 to the housing 10 and for allowing the bracing member 20 to be pivoted or rotated relative to the housing 10, such as to be pivoted or rotated toward and into the spaces 16 of the side walls 12, 13 (FIGS. 2, 3) at the folded or storing position, or to be pivoted or rotated away from the housing 10 and out of the spaces 16 of the side walls 12, 13 (FIG. 6) at the outwardly extending or working position.

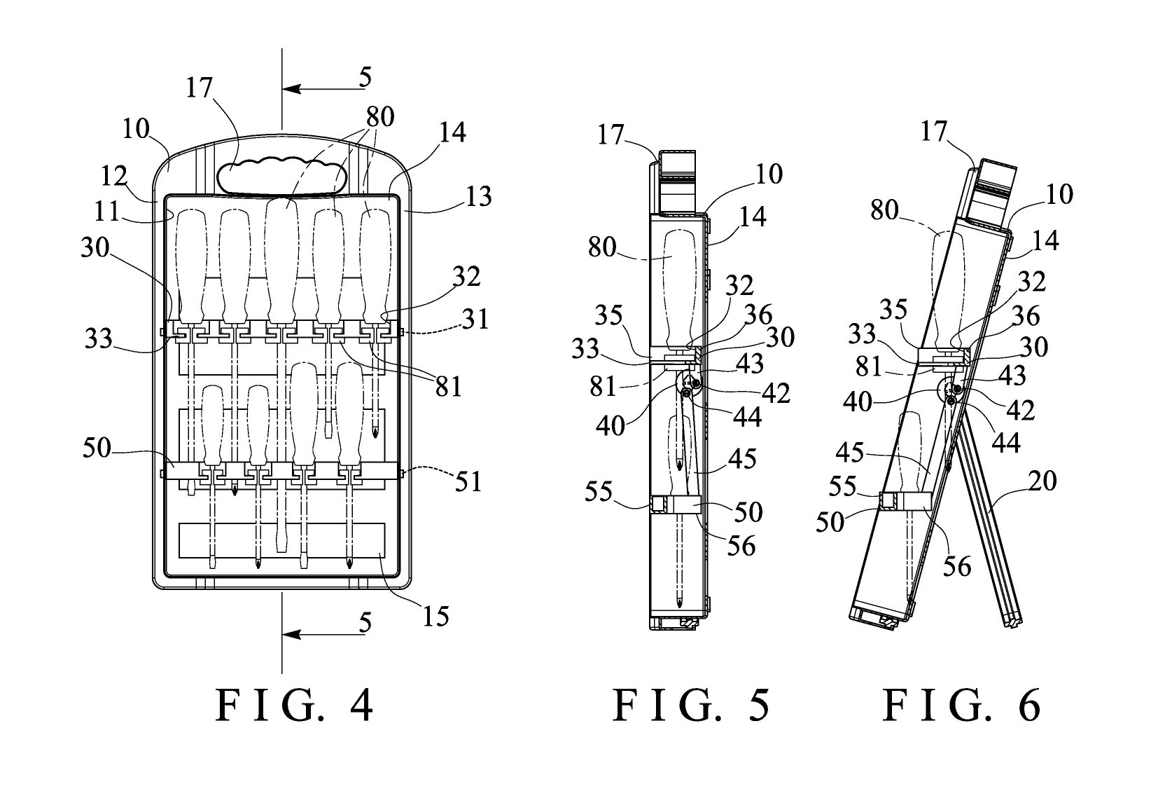

A platform or shelf or tool supporting member 30 is disposed or engaged into the chamber 11 of the housing 10, and includes a pivot shaft or axle 31 provided thereon or extended therefrom (FIGS. 1, 2) and engaged with the side walls 12, 13 (FIG. 4) for pivotally or rotatably attaching or mounting or securing or coupling the tool supporting member 30 to the housing 10 and for allowing the tool supporting member 30 to be pivoted or rotated relative to the housing 10 (FIGS. 5, 6), and includes one or more socket openings 32 formed therein and formed or defined by a bottom or base panel 33 which includes an engaging slot 34 formed therein for receiving or engaging with the tool members 80 (FIGS. 4-6) directly, or indirectly with supporting or engaging devices 81. It is preferable that the pivot axle 31 is located at or close to the front portion 35 of the tool supporting member 30, for allowing the rear portion 36 of the tool supporting member 30 to be pivoted or rotated or moved up and down relative to the housing 10 (FIGS. 5, 6).

Two discs or followers 40 are disposed or engaged into the chamber 11 of the housing 10, and attached or mounted or secured to the arms 21, such as to the pivot shafts 22 of the arms 21 respectively, for example, the followers 40 each include a lock or latch member 41 formed or provided thereon for engaging with the pivot shaft 22 or the arm 21 and for solidly and stably attaching or mounting or securing or coupling the followers 40 to the arms 21 respectively and for allowing the followers 40 to be moved in concert with the arms 21 respectively, and to be pivoted or rotated in concert with the pivot shafts 22 of the arms 21 respectively. The followers 40 each include an eccentric pin or member 42 extended therefrom and pivotally or rotatably coupled to the rear portion 36 of the tool supporting member 30 with a link 43 for allowing the tool supporting member 30 to be pivoted or rotated relative to the housing 10 with or by the bracing member 20 when the bracing member 20 is pivoted or rotated relative to the housing 10 (FIGS. 5, 6).

For example, as shown in FIGS. 3 and 5, when the bracing member 20 is folded or stored or received or engaged in the spaces 16 of the side walls 12, 13, the tool supporting member 30 is not pivoted or rotated relative to the housing 10 with or by the bracing member 20, and the tool supporting member 30 is supported in a folded or storing position substantially perpendicular to the side walls 12, 13 and the bottom wall 14 of the housing 10. On the contrary, as shown in FIG. 6, when the bracing member 20 is folded or pivoted or rotated out of the side walls 12, 13 at the outwardly extending or working position, the tool supporting member 30 may be pivoted or rotated relative to the housing 10 with or by the bracing member 20 to the working position where the tool supporting member 30 is tilted or inclined relative to the side walls 12, 13 and the bottom wall 14 of the housing 10 for suitably supporting the tool members 80 in place.

Another platform or shelf or tool supporting element 50 is also disposed or engaged into the chamber 11 of the housing 10, and includes a pivot shaft or axle or spindle 51 provided thereon or extended therefrom (FIGS. 1, 2) and engaged with the side walls 12, 13 (FIG. 4) for pivotally or rotatably attaching or mounting or securing or coupling the tool supporting element 50 to the housing 10 and for allowing the tool supporting element 50 to be pivoted or rotated relative to the housing 10 (FIGS. 5, 6), and includes one or more socket openings 52 formed therein and formed or defined by a bottom or base panel 53 which includes an engaging groove 54 formed therein for receiving or engaging with the tool members 80 (FIGS. 4-6) directly, or indirectly with supporting or engaging devices 81. It is preferable that the pivot spindle 51 is located at or close to the front portion 55 of the tool supporting element 50, for allowing the rear portion 56 of the tool supporting element 50 to be pivoted or rotated or moved up and down relative to the housing 10 (FIGS. 5, 6).

One of the followers 40 include another eccentric pin or pole or rod or element 44 extended therefrom and pivotally or rotatably coupled to the rear portion 56 of the tool supporting element 50 with another link or lever 45 for allowing the tool supporting element 50 to be pivoted or rotated relative to the housing 10 with or by the follower 40 and the bracing member 20 when the bracing member 20 is pivoted or rotated relative to the housing 10 (FIGS. 5, 6), and for suitably supporting the tool members 80 in place when the bracing member 20 is pivoted or rotated relative to the housing 10 (FIGS. 5, 6) and when the housing 10 is supported at the working position and tilted or inclined relative to the supporting ground or surface or table (FIG. 6).

In operation, as shown in FIGS. 3-5, when the housing 10 is erected and supported on the supporting ground or surface or table at the storing position where the housing 10 is erected and perpendicular to the supporting ground or surface or table, the tool supporting member 30 and the tool supporting element 50 will be supported in the housing 10 at the storing position where the tool supporting member 30 and the tool supporting element 50 are substantially perpendicular to the side walls 12, 13 and the bottom wall 14 of the housing 10 for suitably supporting the tool members 80 in the housing 10. On the contrary, as shown in FIG. 6, when the bracing member 20 is folded or pivoted or rotated out of the side walls 12, 13 at the outwardly extending or working position, both the tool supporting member 30 and the tool supporting element 50 may be pivoted or rotated relative to the housing 10 with or by the bracing member 20 to the working position where the tool supporting member 30 and the tool supporting element 50 are tilted or inclined relative to the side walls 12, 13 and the bottom wall 14 of the housing 10 for suitably supporting the tool members 80 in place.

Accordingly, the tool box in accordance with the present invention includes a pivotal or rotatable supporting mechanism for pivotally or rotatably and solidly and stably supporting the tool members or elements in the tool box and for preventing the tool members or elements from being disengaged or separated from the tool box inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool box comprising:
a housing including a chamber formed therein and defined by two side walls,
a bracing member including two arms each having a pivot shaft engaged with said side wall of said housing for pivotally attaching said bracing member to said housing and for allowing said bracing member to be pivoted toward and away from said housing,
a tool supporting member disposed in said chamber of said housing, and including a pivot axle engaged with said side walls for pivotally mounting said tool supporting member to said housing and for allowing said tool supporting member to be pivoted relative to said housing, and
two followers attached to said arms respectively, and each follower including an eccentric member extended therefrom and coupled to said tool supporting member for pivoting said tool supporting member relative to said housing with said bracing member when said bracing member is pivoted relative to said housing.

2. The tool box as claimed in claim 1, wherein said eccentric member of said follower is pivotally coupled to said tool supporting member with a link.

3. The tool box as claimed in claim 1, wherein said pivot axle of said tool supporting member is located a front portion of said tool supporting member, and said eccentric member of said follower is pivotally coupled to a rear portion of said tool supporting member.

4. The tool box as claimed in claim 1, wherein said followers are attached to said pivot shafts of said arms respectively.

5. The tool box as claimed in claim 4, wherein said followers each include a latch member engaged with said pivot shafts of said arms respectively for securing said followers to said pivot shafts of said arms respectively.

6. The tool box as claimed in claim 1, wherein said housing includes a space formed in each of said side walls for receiving and engaging with said arms of said bracing member respectively.

7. The tool box as claimed in claim 1, wherein said tool supporting member includes at least one socket opening formed therein for engaging with a tool member.

8. The tool box as claimed in claim 7, wherein said tool supporting member includes a base panel for defining said at least one socket opening of said tool supporting member, and said base panel includes an engaging slot formed therein for engaging with the tool member.

9. The tool box as claimed in claim 1, wherein said housing includes a tool supporting element disposed in said chamber of said housing and having a pivot spindle engaged with said side walls for pivotally mounting said tool supporting element to said housing and for allowing said tool supporting element to be pivoted relative to said housing.

10. The tool box as claimed in claim 9, wherein one of said followers include an eccentric element extended therefrom and coupled to said tool supporting element for pivoting said tool supporting element relative to said housing with said bracing member when said bracing member is pivoted relative to said housing.

11. The tool box as claimed in claim 10, wherein said eccentric element of said follower is pivotally coupled to said tool supporting element with a lever.

12. The tool box as claimed in claim 10, wherein said pivot spindle of said tool supporting element is located a front portion of said tool supporting element, and said eccentric element of said follower is pivotally coupled to a rear portion of said tool supporting element.
